(19) United States
(12) Patent Application Publication
(10) Pub. No.: US 2007/0126147 A1
(43) Pub. Date: Jun. 7, 2007

(54) Method of producing a nanomaterial, and a nanomaterial

(75) Inventors: Shigenori Fujikawa, Wako-shi (JP); Toyoki Kunitake, Wako-shi (JP)

Correspondence Address: BIRCH STEWART KOLASCH & BIRCH, PO BOX 747, FALLS CHURCH, VA, 22040-0747, US

(73) Assignee: Riken, Wako-shi, Saitama (JP)

(21) Appl. No.: 10/555,663

(22) PCT Filed: May 7, 2004
(86) PCT No.: PCT/JP04/06489

§ 371 Date: Dec. 4, 2006

(30) Foreign Application Priority Data
May 7, 2003 (JP) 2003-129347
Feb. 9, 2004 (JP) 2004-032280

(51) Int. Cl. B28B 1/14

(52) U.S. Cl. 264/299

(57) ABSTRACT

A method for producing a metal oxide nanostructure or an organic/metal oxide composite nanostructure of forming a mold on a solid base by a lithographic method, forming a metal oxide thin film or an organic/metal composite thin films on the mold, and then removing the mold is disclosed. With this method, three-dimensional nanostructures can be mass-produced at a low cost.

### TECHNICAL FIELD

The present invention relates to a method of producing a nanomaterial, and the nanomaterial. More specifically, the invention relates to a method of producing a nanomaterial capable of mass producing a three-dimensional nanostructural body by using a mold formed by a lithographic method at a reduced cost, as well as the nanomaterial.

### Background Art

Since composite materials comprising metal oxides or organic compounds and metal oxides having a three dimensional nanostructural body show physical and chemical characteristics different from those of corresponding bulk materials, they have attracted a remarkable attention both in view of basic and applied researches. For example, hollow nanostructural bodies have been expected to be useful in various fields including chemistry, electrochemistry, material, bio medical engineering, sensor, catalytic effect and separation technique.

Heretofore, the hollow nanostructural bodies have been manufactured by a method referred to as a mold method. For example, there has been known a method of producing a spherical capsule structure by coating the surface of fine particles dispersed in a solution with a thin film and removing fine mold particles (for example, refer to Frack Caruso, “Nanoengineering of Particle Surfaces”, Advanced Materials 13 (1), pp 11-22 (2001)). However, this method involves a problem that it is difficult to form a nanosize mold structural body capable of being dispersed in a solution and undergoes a limit in view of the design of the mold structure.

On the other hand, there has been known a method of directly producing a sterical structural body, for example, by a sterical lithographic method by laser drawing (refer, for example, to “Fundamentals of Microfabrication, the science of Miniaturization” written by Marc J. Madou, second edition, CRC Press Co (USA), pp 66-67). However, since the size of a pattern prepared on a solid substrate is at a micro meter order in this method, it involves a subject that manufacture of a nanosize structural body is difficult.

### DISCLOSURE OF THE INVENTION

As described above, the existent mold method undergoes a large restriction in view of the size and the design of the shape and it has been demanded for the development of a novel production method of a three dimensional nanostructural body capable of overcoming the subject. Then, the object of the invention is to provide a novel method of producing a nanomaterial forming a three dimensional nanostructural body by using a mold, and the nanomaterial.

The present inventors have found a method capable of mass producing a three dimensional nanostructural body which required complicated process or the manufacture per se was difficult in the existent method by using a mold formed by a lithographic method and have accomplish the invention.

That is, an object of the invention is attained by a method of producing a nanomaterial comprising forming a mold by a lithographic method on a solid substrate, forming a metal oxide thin film or an organic/metal oxide composite thin film on the formed mold, and removing the formed mold to form a metal oxide nanostructural body or an organic/metal oxide composite nanostructural body, or a method of producing a nanomaterial comprising forming a mold on a solid substrate by a lithographic method, forming a polymeric thin film on the formed mold, forming a metal oxide thin film or an organic/metal oxide composite thin film on the formed polymeric thin film, and removing the formed polymeric thin film or the mold and the polymeric thin film thereby forming a metal oxide nanostructural body or an organic/metal oxide composite nanostructural body.

Further, the production method of the invention can further has removing a portion corresponding to an organic compound contained in the organic/metal oxide composite thin film. Further, the production method of the invention can comprise separating the solid substrate or the solid substrate and the mold, and the metal oxide nanostructural body, the organic/metal oxide composite nanostructural body, and a structural body removed with a portion corresponding to the organic compound contained in the organic/metal oxide composite thin film has been removed. Further, the production method of the invention can further comprise covering at least a portion of the metal oxide nanostructural body, the organic/metal oxide composite nanostructural body, or a structural body removed with a portion corresponding to the organic compound contained in the organic/metal oxide composite thin film.

Further, in the production method of the invention, the following processes are conducted at least once in the step of forming the metal oxide thin film or the organic/metal oxide composite thin film; (a) a process of bringing a metal compound or an (organic compound +metal compound) having groups capable of conducting condensing reaction with hydroxyl groups or carboxyl groups which is present at or introduced in the forming surface and forming a hydroxyl group by hydrolysis into contact with the forming surface, and (b) a process for hydrolyzing the metal compound present at the forming surface to obtain a metal oxide.

Further, in the production method of the invention, a mold comprising an organic compound is preferably used as a mold. Further, in the production method of the invention, removal of the mold, the polymeric thin film and/or the organic compound contained in the organic/metal oxide composite thin film is conducted by at least one of treating methods selected from plasma, ozone oxidation, leaching and baking.

Another object of the invention is attained by a nanomaterial having a structure removed with a portion corresponding to a mold from a structural body in which a mold, a metal oxide thin film, or an organic/metal oxide composite thin film are formed in this order on a solid substrate, or a nanomaterial having a structural body removed with a portion corresponding to a polymeric thin film or a mold and the polymeric thin film from a structural body in which the mold, the polymeric thin film, and a metal oxide thin film or an organic/metal oxide composite thin film are formed in this order on a solid substrate.

The nanomaterial of the invention can further has a structure removed with a portion corresponding to the organic compound contained in the organic/metal oxide composite thin film has been removed. Further, the nanomaterial according to the invention can has a structure wherein the solid substrate or the solid substrate and the mold is separated. Further, the nanomaterial of the invention can have a structural body in which at least a portion of the metal oxide nanostructural body, the organic/metal oxide composite nanostructural body, or a structural body removed with a portion corresponding to an organic compound contained in the organic/metal oxide composite thin film is covered with an organic compound layer. Further, in the nanomaterial of the present invention, removal of mold, the polymeric thin film, or the portion corresponding to the organic compound contained in the organic/metal oxide composite thin film is conducted by at least one of treatments selected from the group consisting of plasma, ozone oxidation, leaching and baking. Further, the nanomaterial of the invention is preferably a nanomaterial obtained by the production method according to the invention. Further, the nanomaterial of the invention can be a material having self-sustainability.

In the production method of the invention, a metal oxide thin film or an organic/metal oxide composite thin film is formed on a mold formed by a lithographic method and then the mold is removed. Thus, according to the production method of the invention, it is possible to produce a nanomaterial having a metal oxide nanostructural body or an organic/metal oxide composite nanostructural body having a shape replicating or transcribing the shape of the formed mold easily and in a great amount. Further, in the production method of the invention, by forming a polymeric thin film between the mold and the metal oxide thin film or the organic/metal oxide composite thin film, and removing the polymeric thin film, the nanomaterial can be separated easily from the solid substrate and the mold, and the mold can be used repetitively. Further, in the production method of the invention, since the metal oxide thin film and the organic/metal oxide composite thin film are formed by a sol-gel method, the thickness of the metal oxide nanostructural body, the organic/metal oxide composite nanostructural body and, further, a structural body removed with a portion corresponding to the organic compound contained in the organic/metal oxide composite thin film can be controlled at a molecular level. Further, in the production method of the invention, since the mold, the polymeric thin film or a portion corresponding to the organic compound contained in the organic/metal oxide composite thin film can be removed by at least one of treating methods selected from plasma, ozone oxidation, leaching, and baking, the mold, the polymeric thin film and/or the organic compound contained in the organic/metal oxide composite thin film can be removed under control by changing the condition of the treating method.

Further, the nanomaterial of the invention has a structure in which the mold, the mold and polymeric thin film, or a portion corresponding to the organic compound contained in the organic/metal oxide composite thin film has been removed from the structural body where the mold or the mold and the polymeric thin film, and the metal oxide thin film or the organic/metal oxide composite thin film are formed in this order on the solid substrate. Thus, the nanomaterial of the invention can be a metal oxide nanostructural body, an organic/metal oxide composite structural body or a structural body removed with a portion corresponding to the organic compound contained in the organic/metal oxide composite thin film accurately replicating or transcribing the shape of the mold. Further, the nanomaterial of the invention has self-sustainability or has stable form and durability by covering at least a portion thereof with an organic compound layer.

In the production method of the invention, after forming the metal oxide thin film or the organic/metal oxide composite thin film on the mold or the polymeric thin film formed by the lithographic method, the mold or the mold and the polymeric thin film is removed. Thus, according to the production method of the invention, a nanomaterial having a shape replicating or transcribing the shape of the formed mold can be produced easily and in a great amount. Further, according to the production method of the invention, the nanostructural body can be separated easily from the solid substrate and the mold by removing the polymeric thin film formed between the mold and the metal oxide thin film or the organic/metal oxide composite thin film, as well as the nanostructural body can be manufactured by using the separated mold repetitively. Further, according to the production method of the invention, since the metal oxide thin film or the organic/metal oxide composite thin film is formed by the sol-gel method, the thickness of the metal oxide nanostructural body or the organic/metal oxide composite nanostructural body can be controlled at a molecular level. Further, according to the production method of the invention, since the mold, the polymeric thin film or the portion corresponding to the organic compound contained in the organic/metal oxide composite thin film can be removed by at least one of treating methods selected from plasma, ozone oxidation, leaching and baking, the mold, the polymeric thin film and/or the portion corresponding to the organic compound contained in the organic/metal oxide composite thin film can be removed under control by changing the condition for the treating method.

Further, the nanomaterial of the invention has a structure in which the mold or the mold and the portion corresponding to the polymeric thin film have been removed from the structural body in which the mold or the mold and the polymeric thin film, the metal oxide thin film or the organic/metal oxide composite thin film are formed in this order on the solid substrate have been removed. Thus, according to the invention, a nanomaterial of a three dimensional structure replicating or transcribing the shape of the mold can be provided. Further, according to the invention, a nanomaterial having self-sustainability and having stable form and durability coated for at least a portion thereof with an organic compound layer can be provided.

### BRIEF DESCRIPTION OF THE DRAWINGS

FIG. 1 is a cross sectional view of a titania nanotube material manufactured in Example 1 by a scanning type electron microscope.

FIG. 2 shows scanning type electron microscopic images for a titania nanotube material manufactured in Example 2.

FIG. 3 shows scanning type electron microscopic images (1) for a titania nanotube material manufactured in Example 3.

FIG. 4 shows scanning type electron microscopic images (2) for a titania nanotube material manufactured in Example 3.

FIG. 5 shows scanning type electron microscopic images for a titania nanotube material manufactured in Example 4.

FIG. 6 shows scanning type electron microscopic images for a titania nanotube material manufactured in Example 5.

FIG. 7 shows scanning type electron microscopic images (1) for a titania nanotube material manufactured in Example 6.

FIG. 8 shows scanning type electron microscopic images (2) for a titania nanotube material manufactured in Example 6.

### DETAILED DESCRIPTION OF THE INVENTION

A method of producing a nanomaterial, and a nanomaterial according to the present invention are to be described below.

In the present specification, “to” means a range including numerical values described before and after thereof as a minimum value and a maximum value respectively.

Further, in the present specification, “nanostructural body” means a closed or partially opened hollow structural body having a thickness at a nanometer level and includes a single hollow body, as well as an assembly in which a plurality of hollow bodies are assembled.

[Production Method of Nano-Material]

<Solid Base>

In the production method of the present invention, a mold is formed on a solid substrate by a lithographic method. The solid substrate used in the present invention is not particularly limited for the type so long as a mold can be formed thereon. Preferably, it is a solid substrate having a reactive group (preferably, hydroxyl group or carboxyl group) on the surface, or capable of being introduced with a reactive group. The solid substrate of the invention includes typically solid materials comprising inorganic materials such as metals, for example, silicon or aluminum, glass, titanium oxide, silica and mica, and solid substrate comprising organic compounds such as acrylic plate, polystyrene, cellulose, cellulose acetate, and phenol resin. Particularly, a silicon wafer or a glass substrate can be used suitably as the substrate.

The size, the shape, etc. of the solid substrate used in the production method of the present invention have no particular restriction. In the production method of the invention, since a mold is formed on the solid substrate, it is not always necessary that the solid substrates has a smooth surface and bases of various materials or shape can be selected properly. For example, they can cope with various materials including various shapes such as a substrate having a curved surface, a flat plate having uneven surface, flaky shape, etc.

<Mold>

The mold used for the production method of the invention is formed by a lithographic method. The lithographic method is not particularly limited in the invention and known lithographic method can be adopted. For example, in the production method of the present invention, photolithograph, X-ray lithographic method, electron beam lithographic method, etc. can be used suitably.

In the invention, the material for forming the mold is not restricted to organic compounds but metals, metal oxides and composite products thereof, organic/inorganic composite materials, etc. can be used and, while they can not be generally defined, it is suitable to use organic materials. Further, since the metal oxide thin film is formed on the mold, the material forming the mold is preferably a material capable of providing reactive groups such as hydroxyl groups or carboxyl groups on the surface of the mold.

In the lithographic method using a resist material, the mold can be formed by coating and spreading the resist material on the solid substrate. The resist material to be used can be determined properly depending on the wavelength of a light to be irradiated, and exposure/developing method and can include, for example, organic resist materials such as novolac polycresole, polymethacrylate ester, fluoro resin and copolymers thereof, as well as inorganic resist materials. For the resist material, organic resist materials are used preferably in a case of removing the mold by using an oxygen plasma treatment, ozone oxidation treatment or baking treatment and further inorganic resist material can be used in a case of removing them by using a leaching treatment.

The film thickness of the mold formed on the solid substrate can be adjusted properly depending on the nanomaterial to be produced and, while it can not be defined generally, it can be determined within a range about from several tens nm to several μm and, preferably, it is within a range from 100 to 500 nm.

In a case of forming a pattern in the mold, the pattern width of the mold can be properly adjusted in accordance with the shape of the mold to be manufactured, the resist material to be used, the length of a light to be irradiated and the aspect ratio for the width and the height, and distance to an adjacent pattern. Specifically, the pattern width of the mold can be within a range from several tens nm to several μm.

For the mold, in a case of using the resist material, a light is irradiated to the solid substrate coated with a resist material by way of a mask having an aperture pattern to expose the resist material on the solid substrate. While the wavelength of the light to be irradiated is different depending on the light absorption of the coated resist material, the thickness of the resist material, the size of the mold structure to be drawn, etc. and can not be restricted generally but it can be determined generally within a range from a far infrared region at several μm to extreme ultra violate ray or X-ray at several nm.

In the invention, exposure to the resist material is not restricted to a method of utilizing the mask. A method of applying pattern exposure directly by scanning of light or electron beam is also applicable. Finally, by developing the exposed resist material, the mold can be prepared. Further, either the positive type or the negative type can be utilized for the type of development.

Further, in the invention, it is not restricted to fine fabrication technique by the method utilizing the resist material for the mold but a method of forming a structure directly on the solid substrate can also be utilized. For example, a method of directly irradiating an ion beam to a solid substrate to conduct etching thereby forming a fine structure can also be utilized. Further, it is also possible to utilize a fine structure prepared by urging a substrate previously fabricated finely to transcribe a structure to another substrate can also be utilized.

In the production method of the invention, in a case where the mold has no reactive groups on the surface, it can be used as the mold of the invention by additionally introducing a reactive group to the surface of the mold. As the method of introducing a reacting groups to the surface of the mold, a known method of introducing reactive groups (for example, known introduction method of hydroxyl group, carboxyl group, etc.) can be adopted. For example, in a case where the mold has no hydroxyl groups, the hydroxyl groups can be introduced by adsorbing mercapto ethanol or the like to the surface of the mold. Further, the mold surface can be activated also by applying a treatment such as a plasma treatment or an ozone oxidation.

The amount per unit surface area of the reactive groups (preferably, hydroxyl group or carboxyl group) to be present on the surface of the mold gives an effect on the density of the metal compound thin film formed on the mold. For example, in a case of forming a favorable metal oxide thin film, the amount of the hydroxyl groups or the carboxyl groups is, appropriately, from 5.0×10¹³ to 1.0×10¹⁵ equivalent amout/cm² and, preferably, from 1.0×10¹⁴ to 5.0×10¹⁴ equivalent amout/cm².

<Polymeric Thin Film>

In the production method of the invention, a polymeric thin film can be formed between the mold and the metal oxide thin film and/or organic/metal oxide composite thin film. By forming the polymeric thin film as an intermediate layer, it is possible to easily form a metal oxide nanostructural body, an organic/metal oxide composite nanostructural body or a structural body removed with a portion corresponding to the organic compound contained in an organic/metal oxide composite thin film. Further, since the mold after removing the polymeric thin film can maintain the original mold structure, the mold can be used repetitively.

The polymer constituting the polymeric thin film described above is preferably those providing reactive groups (preferably, hydroxyl groups or carboxyl groups) on the surface of the thin film and are not easily soluble to a solvent used upon preparing a metal oxide thin film or an organic/metal oxide composite thin film to be described later. For example, in a case where the solvent used for the manufacture of the metal oxide thin film or the organic/metal oxide composite thin film is water, polymers such as polyvinyl phenol or polyvinyl phenol type polymer for photoresist which is insoluble to water but easily soluble to ethanol, methyl polymethacrylate, vinyl poly acetate, hydroxyl propyl methyl cellulose phthalate soluble to acetone or the like, polystyrene soluble to chloroform or the like can be used suitably.

Further, as the polymer, cationic polymers can also be used preferably. Since metal alkoxides or metal oxides can interact anionically to cations of cationic polymeric compounds, strong adsorption can be attained. Specific examples of the cationic polymeric compounds used preferably in the invention include PDDA (polydimethyl allyl ammonium chloride), polyethylene imine, polylysine, chitoson, and dendrimers having amino groups at the terminal ends.

Further, the polymer providing the hydroxyl groups or the carboxyl group on the surface of the formed polymeric thin film includes, for example, polyvinyl alcohol, polyvinyl phenol, polyacrylic acid, polymethacryl acid, poly(2-hydroxyethyl methacrylate) or polyglutamic acid, polyselin, amylose, and colominic acid. In the invention, considering the function (or role) of the polymeric thin film, it is not particularly limited to the organic polymer but an organic low molecular material can be utilized as well so long as the material can remove only the polymeric thin film selectively from the mold structure, the polymeric thin film and the metal oxide thin film or the organic/metal oxide composite thin film.

The polymer described above can be formed on the mold also by a method of dissolving the same into an appropriate solvent to form a solution and dipping a mold in the solution (dip coating method), a method of laminating the solution on the mold by a spin coating method, as well as a Langmuir project method, an alternating adsorption method or the like. By the procedures described above, a surface providing reactive groups uniformly over the entire area on the mold surface can be formed. That is, reaction sites for the metal compound or the (organic compound +metal compound) are provided uniformly over the entire area of the mold surface and, as a result, a uniform metal oxide thin film or organic/metal oxide composite thin film can be formed on the mold surface.

The solvent used for solving the polymer is not particularly limited and, for example, methanol, ethanol, propanol, toluene, carbon tetrachloride, chloroform, cyclohexane, benzene, etc. can be used each alone or as a mixture of them.

The amount of the reactive groups (preferably, hydroxyl groups or carboxyl groups) to be present on the surface of the polymeric thin film gives an effect on the density of the metal oxide thin film formed in the next step. In a case of forming a preferred metal oxide thin film, a range, generally, from 5.0×10¹³ to 1.0×10¹⁵ equivalent amount/cm² and, preferably, from 1.0×10¹⁴ to 5.0×10¹⁴ equivalent amout/cm² is appropriate.

<Metal Oxide Thin Film and Organic/Metal Oxide Composite Thin Film>

In the production method of the invention, a metal oxide thin film or an organic/metal oxide composite thin film can be formed on the mold or the polymeric thin film. Both the metal oxide thin film and the organic/metal oxide composite thin film can be formed by a sol-gel method, that is, by contacting a metal compound capable of condensing reaction with reactive groups (preferably, hydroxyl groups or carboxyl groups) present at or introduced to the surface of the mold or the polymeric thin film and capable of forming hydroxyl groups by hydrolysis and hydrolyzing the metal compound.

In the production method of the invention, in a case of forming the metal oxide thin film, a solution containing a metal compound containing solution is brought into contact with the mold or the polymeric thin film. In a case of forming the organic/metal oxide composite thin film, a solution containing the (organic compound+metal compound) is brought into contact with the mold or the polymeric thin film. The method of bringing the solution containing the metal compound or the solution containing the (organic compound+metal oxide) into contact with the mold or the polymeric thin film is not particularly limited and it can be also formed, for example, by dipping a solid substrate formed with the mold or the polymeric thin film in a solution containing the metal compound or containing the (organic compound+metal oxide) (dip coating method), a method of laminating the solution by a spin coating method on the mold or the polymeric thin film, as well as an alternating adsorption method.

In a case of adsorbing the solution containing the metal compound or the (organic compound+metal compound) on the mold or the polymeric thin film, the metal compound or the (organic compound+metal compound) is not only strongly adsorbed chemically to the surface of the mold or the polymeric thin film but also adsorbed excessively as weak physical adsorption species. When they are washed for appropriate time and temperature, only the weak physical adsorption species are cleaned to form a thin film at a nanometer level of the metal compound or the (organic compound+metal compound) on the surface of the mold or the polymeric thin film.

Further, since the thickness of the adsorption layer can always be kept constant, for example, by using a spin coating method, the adsorption layer can be utilized without cleaning as the film constituent ingredient.

“Chemical adsorption” in the present specification means a state that chemical bonding (covalent bonding, hydrogen bonding, coordination bonding, etc.) or electrostatic bonding (ionic bonding, etc.) is formed between the reactive groups (preferably, hydroxyl group or carboxyl group) present on the surface of the mold or the polymeric thin films and the metal compound, metal ion or the (organicmetal+metal compound) and the metal compound, the metal ion or the (organic compound+metal compound) is bonded to the surface of the mold or the polymeric thin film.

Then, when a layer in which the metal compound or the (organic compound+metal compound) is present is immersed in water at an appropriate temperature for an appropriate time or exposed to air containing steams, molecules of the metal compound present on the surface are hydrolyzed and condensed to each other to form a metal oxide thin film or an organic/metal oxide composite thin film and, at the same time, additional hydroxyl groups are formed on the surface. Simultaneously with the hydrolysis, a reaction that metal atoms of the metal compound are oxidized in air to form metal oxide may sometimes occur. When additional reactive groups are formed on the surface, a metal oxide thin film can be again formed thereon by utilizing the reactive groups. By repeating such procedures, the metal oxide thin film or the organic/metal oxide composite thin film can be formed successively on the mold or the polymeric thin film.

Metal compounds used for the metal oxide thin film or the organic/metal oxide composite thin film are preferably those capable of condensation reaction with the reactive groups (preferably, hydroxyl groups or carboxyl groups) and forming hydroxyl groups by hydrolyses. Typical metal compounds include, for example, metal alkoxide compounds such as titanium butoxide (Ti(O-nBu)₄), zirconium propoxide (Zr(O-nPr)₄), aluminum butoxide (Al(O-nBu)₃), niobium butoxide (Nb(O-nBu)₅), silicon tetramethoxide (Si(O-Me)₄), boron ethoxide (B(O-Et)₃); metal alkoxides having two or more alkoxyl groups such as methyl trimethoxy silane (MeSi(O-Me)₃) and diethyl ethoxy silane (Et₂Si(O-Et)₂); metal alkoxides having a ligand such as acetyl acetone and having two or more alkoxyl groups; metal alkoxides of rare earth elements such as lanthanide isopropoxide (Ln(O-iPr)₃), and yttrium propoxide (Y(O-iPr)₃); and double alkoxide compound such as BaTi(OR)ₓ.

In addition to the metal alkoxides described above, alkoxide sols or fine particles of the alkoxide sols or alkoxide gels obtained by adding a small amount of water to the metal alkoxides described above and partially hydrolyzing and condensing them, titanium butoxide tetramer (C₄H₉O[Ti(OC₄H₉)₂O]₄C₄H₉), binuclear or cluster type alkoxide compounds having plurality of or plurality species of metal elements, polymers based on the metal alkoxide compounds cross linked lineally by way of hydrogen atoms can also be used as the compound having the metal alkoxide groups of the invention.

Further, metal complexes capable of adsorbing with the reactive groups on the surface of the mold or the polymeric thin film and forming additional hydroxyl groups on the surface by hydrolysis are also included in the metal compound of the invention. The metal complex includes, specifically, metal halides such as cobalt chloride (CoCl₂), titanium oxoacetyl acetate (TiO(CH₃COCH₂COO))₂), pentacarbonyl iron (Fe(Co)₅), and polynuclear clusters thereof.

Further, the metal compounds used in the invention also include isocyanate metal compounds having two or more isocyanate groups (M(NCO)ₓ) such as tetraisocyanate silane (Si(NCO)₄), titanium tetraisocyanate (Ti(NCO)₄), zirconium tetraisocyanate (Zr(NCO)₄), aluminum triisocyanate (Al(NCO)₃) and, further, metal halide compounds having two or more halogen (MXₙ, in which M represent a metal, X is one species selected from F, Cl, Br, and I, and n is an integer from 2 to 4), such as tetrachloro titanium (TiCl₄) and tetrachlorosilane (SiCl₄).

Further, the metal compounds can also be used optionally by combining two or more of the metal compounds. A thin film comprising a composite metal compounds can also be formed on the surface of the mold or polymeric thin film by combining different species of metal compounds.

The solvent for dissolving the metal compound is not particularly limited. For example, as the solvent, methanol, ethanol, propanol, hexane, heptane, toluene, benzene and the like may be used each alone or in admixture thereof. The concentration of the solution in which the metal compound is dissolved is about from 1 to 200 mM, preferably, from 50 to 150 mM and, more preferably, from 50 to 100 mM. In a case where the concentration of the metal compound (+organic compound) is from 1 to 200 mM, the metal oxide thin film or the organic/metal oxide composite thin film can be formed uniformly.

The production method according to the invention can form the metal oxide thin film described above, as well as, the organic/metal oxide thin film comprising the above metal compound and the organic compound on the mold or the polymeric thin film. The organic compound used for forming the organic/metal oxide composite thin film is not particularly limited so long as it is soluble to the solvent used for forming the composite thin film and it may be of the kind identical with or different from the polymer described above. ‘Soluble’ refereed to herein is not restricted to the case where the organic compound is dissolved alone but also a case where it is dissolved in composition with the metal alkoxide into a solvent such as chloroform as in 4-phenylazobenzoate. Also the molecular weight of the organic compound is not particularly restricted.

With a view point of making the contact with the mold or the polymeric thin film more strong, it is preferred to use those having a plurality of reactive groups (preferably, hydroxyl groups or carboxyl groups) and being solid in nature at a room temperature (25° C.). As the organic compound described above, polymer compounds having hydroxyl groups or carboxyl groups such as polyacrylic acid, polyvinyl alcohol, polyvinyl phenol, polymethacrylic acid, polyglutamicacid, etc.; polysaccharides such as starch, glycogen, and colominic acid, disaccharides such as glucose and mannose, monosaccharide; and porphyrin compounds or dendrimers having hydroxyl groups or carboxyl groups at terminal ends.

Further, as the organic compound, the cationic polymer compound described above can also be used preferably. Since the metal alkoxide or the metal oxide can interact anionically to the cation of the cationic polymer compound, it can attain a strong bonding.

The organic compounds can serve not only as the structural ingredient for forming a thin film of high mechanical strength but also as a functional portion for providing the function to the resultant thin film material or as an ingredient to be removed after film formation to form voids in the thin film in accordance with the molecular shape.

The contact time and the contact temperature between the mold or the polymeric thin film and the metal compound or the (organic compound+metal compound) are different depending on the activity of the metal compound to be used and can not be defined generally but it may be decided generally within a range from one minute to several hours and from 0 to 100° C. Further, in the chemical reaction described above, the time necessary for the steps can be shortened remarkably by the use of a catalyst such as an acid or base.

In a case of adsorbing the metal compound or the (organic compound+metal compound) on the surface of the mold or the polymeric thin film by the process described above, a saturation adsorption amount of the metal compound or the (organic compound +metal compound) by chemical adsorption and the metal compound or the (organic compound+metal compound) byphysical adsorption are present respectively. For obtaining a homogenous and uniform metal oxide thin film or organic/metal oxide composite thin film, it is sometimes necessary to remove the metal compound or the (organic compound+metal compound) physically adsorbed in excess on the mold or the polymeric thin film. By removing the metal compound or the (organic compound+metal compound) present in excess, since the metal oxide thin film is formed from the metal compound adsorbed on the surface of the mold or the polymeric thin film and the organic/metal oxide composite thin film is formed from the (organic compound+metal compound) respectively, the metal oxide thin film or organic/metal oxide composite thin film can be formed at an extreme high accuracy and with a high reproducibly based on the existent amount of the metal compound or the (organic compound+metal compound).

The method of removing the excess metal compound or the (organic compound+metal compound) is not particularly restricted so long as it is a method of selectively removing the metal compound or the (organic compound+metal compound). For example, a method of cleaning with an organic solvent for dissolving the metal compound or the (organic compound+metal compound) is suitable. For the cleaning, a method of sucking the organic solvent under a reduced pressure, a method of dipping in and cleaning with an organic solvent, a method of spray cleaning, a method of steam cleaning, and the like can be adopted suitably. Further, for the cleaning temperature, the temperature in the adsorption operation described above is adopted suitably.

In the production method of the invention, after removing the excess metal compound or the (organic compound+metal compound), hydrolysis is conducted for the metal compound present on the surface of the mold or the polymeric thin film. By the hydrolysis, the metal compound is condensed to form a metal oxide thin film or an organic/metal oxide composite thin film on the mold or the polymeric thin film. For the hydrolysis, known methods are adopted with no particular restriction. For example, an operation of bringing a mold or a polymeric thin film in which the metal compound is present on the surface into contact with water is most general. For such water, use of ion exchanged water is preferred in order to prevent intrusion of impurity or the like and form a metal oxide at high purity. Further, in the hydrolysis, the time required for the steps can also be shortened remarkably by using a catalyst such as an acid or a base.

Further, hydrolysis can be conducted also by immersing a metal compound or the (organic compound+metal compound) present on the surface of a mold or a polymeric thin film in an organic solvent containing a small amount of water. Further, in a case where a metal compound of high reactivity with water is incorporated, among the metal compound or the (organic compound+metal compound), hydrolysis may be conducted also by reacting the same with steams in air. After hydrolysis, the thin film surface is optionally dried by a drying gas such as a nitrogen gas. By the procedure, a uniform metal oxide thin film or an organic/metal oxide composite thin film can be obtained.

In the production method of the invention, by repeating the series of the process at least once, preferably, ten times or more and, more preferably, 20 times or more in the step of forming the metal oxide thin film or the organic/metal oxide composite thin film, a uniform metal oxide thin film or an organic/metal oxide composite thin film having a desired thickness can be formed on the mold or the polymeric thin film. That is, control for the thickness of the metal oxide thin film or the organic/metal oxide composite thin film in the production method of the invention can be attained by repeating the operation of contact and hydrolysis of the metal compound or the (organic compound+metal compound).

By repeating the steps described above, a metal oxide thin film or an organic/metal oxide composite thin film at several nanometer to several tens nanometer can be formed accurately according to the production method of the invention. In a case of using a metal alkoxide containing a single kind of metal atoms such as titanium butoxide for the formation of the metal oxide thin film or the organic/metal oxide composite thin film, a thin film at a thickness of several angstrom can be laminated successively depending on the contact condition. In this case, increase of the film thickness per 1 cycle corresponds to the number of lamination of the metal alkoxide. On the other hand, in a case of using fine particles of an alkoxide gel, etc., a thin film at a thickness of about 60 nm can also be laminated per 1 cycle. Further, in a case of forming a metal oxide thin film or an organic/metal oxide composite thin film by a spin coating method, the film thickness can be optionally controlled from several nm to about 200 nm by changing the concentration of the solvent and the alkoxide to be used, the spin speed, etc. Further, by changing the kind of the metal compound or the (organic metal compound+metal compound) to be used, a laminate comprising different kinds of metal oxide thin films or organic/metal oxide composite thin films can also be obtained.

<Removal of Mold, Polymeric Thin Film and/or a Portion Corresponding to the Organic Compound Contained in Organic/Metal Oxide Composite Thin Film>

In the production method according to the invention, the mold, the polymeric thin film and/or the portion corresponding to the organic compound contained in the organic/metal oxide composite thin film is removed from a structural body in which the mold or the mold and the polymeric thin film, the metal oxide thin film or the organic/metal oxide composite thin film are formed successively on a solid substrate. The removing method is not particularly restricted and, with a view point of easy control, it is preferably conducted by at least one kind of treating methods selected from the group consisting of plasma, ozone oxidation, leaching, baking, with the plasma treatment being further preferred.

The treating method described above can be properly determined depending, for example, on the mold ingredient, the kind of the polymer and the organic compound used in the invention, etc. For example, the time, the pressure, the output and the temperature for the plasma treatment can be decided properly in accordance with the type and the size of the mold, the polymeric thin film, the organic compound contained in the organic/metal oxide composite thin film to be applied with the plasma treatment, the plasma source, etc. In the plasma treatment, various kinds of gases such as an oxygen gas, a hydrogen gas, and a nitrogen gas can be used.

For example, in a case of the oxygen plasma treatment, it is appropriate that the pressure during the oxygen plasma treatment is from 1.33 to 66.5 Pa (10 to 500 mtorr), preferably, from 13.3 to 26.6 Pa (100 to 200 mtorr). Further, the plasma output during the oxygen plasma treatment is, appropriately, from 5 to 500 W, preferably, from 10 to 50 W. Further, the treating time during the oxygen plasma treatment is from 5 min to several hours, preferably, from 5 to 60 min. Further, the temperature for the oxygen plasma treatment is at a low temperature, preferably, from −30 to 300° C. and, more preferably, from 0 to 100° C. and, most preferably, at a room temperature (5 to 40° C.). The number of times of the oxygen plasma treatment is not particularly restricted and it can be conducted for once to several times. In this case, the treatment can be conducted also by combining different pressures and plasma outputs. The plasma apparatus used for the oxygen plasma treatment is not particularly limited and, for example, PE-2000 plasma etcher manufactured South Bay Technology (USA) can be used.

Further, the conditions in the ozone oxidation treatment can be decided properly in accordance with the kind of the mold, the polymeric thin film, the organic compound contained in the organic/metal oxide composite thin film to be treated and the apparatus to be used. For example, the pressure during the ozone oxidation treatment is, appropriately, from an atmospheric pressure to 13.3 Pa (100 mtorr), preferably, from 133.3 to 13333.3 Pa (0.1 to 100 torr). The ozone oxidation treatment time can be from several minuets to several hours and, preferably, from 5 to 60 min. The treating temperature can be from a room temperature to 600° C. and, preferably, from the room temperature to 400° C.

Further, for the method of leaching, known leaching methods can be adopted properly in accordance with the kind of ingredients contained in the mold, the polymeric thin film or the organic/metal oxide composite thin film. For example, in a case of preparing the mold with an organic resist material, the organic resist material can be leached selectively by using a polar solvent such as acetone or ethanol. Further, a polymeric thin film comprising polystyrene can be leached selectively by using chloroform, toluene, etc.

Further, the conditions for the baking treatment are at 100 to 1000° C. in an atmospheric air, preferably, at 300 to 500° C. for 30 sec to several hours and, preferably, from 1 to 60 min. Further, in a case of using an easily oxidizable solid substrate such as an Si wafer, the baking treatment is preferably conducted in a nitrogen atmosphere in order to prevent oxidation of the solid substrate. Various conditions for the baking treatment in nitrogen are identical with those in the atmospheric air.

When the mold, the polymeric thin film and/or the portion corresponding to the organic compound contained in the organic/metal oxide composite thin film are removed by the treating method described above, the metal oxide nanostructural body, the organic/metal oxide composite nanostructural body, or the structural body removed with the portion corresponding to the organic compared contained in the organic metal oxide composite thin film is formed on the solid substrate or on the mold. The structure removed with the portion corresponding to the organic compound contained in the organic/metal oxide composite thin film can be an amorphous nanostructural body removed with the organic compound entirely or partially.

In the production method of the invention, the solid substrate or the solid substrate and the mold can be separated further from the structural body. The method of separating the solid substrate or the solid substrate and the mold is not particularly limited and, for example, various kinds of separation methods such as by supersonic waves, scratching and cleaning can be used and the separation method by supersonic waves and cleaning can be used suitably.

Further, the production method according to the invention can comprise covering at least a portion of the separated metal oxide nanostructural body, organic/metal oxide composite nanostructural body or the structure removed with a portion corresponding to the organic compound contained in the organic/metal oxide composite thin film with an organic compound layer. By covering the structural bodies with the organic compound layer, the organic compound layer can serve as a backing material for the structure to improve the durability, the elasticity, etc. of the nanomaterial. The organic compound and the solvent to be used are not particularly limited and, for example, those polymers and solvents described above for the polymeric thin film can be used. Further, the portion covered with the organic compound layer is not particularly limited and, for example, the rearface of the separated metal oxide nanostructural body, the organic/metal oxide composite nanostructural body, or structure removed with a portion corresponding to the organic compound contained in the organic/metal oxide composite thin film can be coated with the organic compound layer.

[Nano-Material of the Invention]

The nanomaterial of the invention has a structure removed with a portion corresponding to the mold and/or the polymeric thin film from a structure in which the mold or the mold and the polymeric thin film, the metal oxide thin film or the organic/metal oxide composite thin film are formed in this order on the solid substrate. In a case of forming the organic/metal oxide composite thin film, the composite film preferably has a portion in which the organic compound is dispersed in the metal oxide, has a portion in which the metal oxide and the organic compound form a layered structure in the direction of the thickness, or comprises a portion in which the organic compound is dispersed in the metal oxide and a portion in which the metal oxide and the organic compound form a layered structure in the direction of the thickness.

In addition to the constitution described above, the nanomaterial of the invention can further have also a structure removed with a portion corresponding to the organic material contained in the organic/metal oxide composite thin film. When the organic compound is removed from the organic/metal oxide composite thin film, a metal oxide thin film having voids in accordance with the shape of the molecules of the organic compound is obtained, which can be utilized as a molecular structure-selective permeation membrane.

“Structure removed with the corresponding portion” described above means a structure having a void corresponding to the spatial arrangement in which the portion corresponding to the organic compound contained in the mold, the polymeric thin film and/or the organic/metal oxide composite thin film were present. That is, it includes a structure (a) in which a portion where the mold and the polymeric thin film were present and/or a portion corresponding to the organic compound contained in the metal oxide composite thin film are left as they are as voids, (b) a structure in which the vicinity around a portion in which a portion where the mold and the polymeric thin film were present and/or a portion corresponding to the organic compound contained in the metal oxide composite thin film are left as the center to form voids, and (c) a structure in which the vicinity around a portion in which a portion where the mold and the polymeric thin film were present and/or a portion corresponding to the organic compound contained in the metal oxide composite thin film are left as the center to form voids, and, further, portions of the voids thereof are connected to each other to form a network shape.

The nanomaterial according to the invention is obtained, preferably, by the production method of the invention. In a case where the solid substrate is contained in the nanomaterial of the invention, since the thickness of the solid substrate is different depending on various kinds of solid substrates, it can not be determined generally but a thickness of about 0.1 to 3 mm is preferred and a thickness of about 0.5 to 1 mm is further preferred. Further, the thickness of the metal oxide thin film or the organic/metal oxide composite thin film depends on the repetitive number of the steps for forming the thin films and it is usually within a range from 1 to 100 nm, preferably, within a range from 10 to 20 nm. Further, the shape of the nanomaterial of the invention can have a shape of replicating or transcribing the mold and can be in various shapes such as a rectangular line shape, linear shape, cylindrical shape, string-like shape, etc. For example, in a case where the nanomaterial of the invention has the rectangular line structure, the width for each line can be within a range from several tens nm to several μm, preferably, from 300 to 500 nm, and the height is within a range from 1 nm to 1 μm and, preferably, from 100 to 500 nm.

The nanomaterial of the invention can further have a structure in which the solid substrate and the mold are separated from the metal oxide nanostructural body, the organic/metal oxide composite nanostructural body, or the structure removed with a portion corresponding to the organic compound contained in the metal oxide nanostructural body. In this case, the nanomaterial is the metal oxide nanostructural body, the organic/metal oxide composite nanostructural body, or the structural body removed with portion corresponding to the organic compound contained in the organic/metal oxide composite thin film, having a shape replicating or transcribing the shape of the mold. The size, the thickness, the height, etc. of the pattern for each of the structural bodies are identical with those of the structure on the solid substrate.

The nanostructural body of the invention can further be a structural body in which at least a portion of the metal oxide nanostructural body, the organic/metal oxide composite nanostructural body, or the structural body removed with a portion corresponding to the organic compound contained in the organic/metal oxide composite thin film is covered with an organic compound layer. In a case of covering the nanostructural body with the organic compound layer, the thickness can be within a range from several tens to several μm, and, preferably, from 100 to 500 nm.

The nanomaterial of the invention is a three-dimensional nanostructural body replicating or transcribing the shape of the mold and has a self-sustainability. The self-sustainability means such a property not restricted only to a case where the metal oxide nanostructural body, the organic/metal oxide composite nanostructural body or the structural body removed with a portion corresponding to the organic compound contained in the organic/metal oxide composite thin film after removing the solid substrate keeps the same three-dimensional form as that before removing the solid substrate but such nanostructural bodies are present without causing irreversible agglomeration into lumpy shape with the surface area of the obtained nanostructural body at a sufficiently large value relative to the film thickness after removing the solid substrate.

The feature of the invention is to be described more specifically with reference to examples.

The material, the amount of use, the ratio, the content of the treatment, the operation for the treatment, etc. shown in the following examples can be properly changed so long as they are not out of the gist of the invention. Accordingly, the scope of the invention should not be construed imitatively by way of the concrete examples shown below.

### EXAMPLE 1

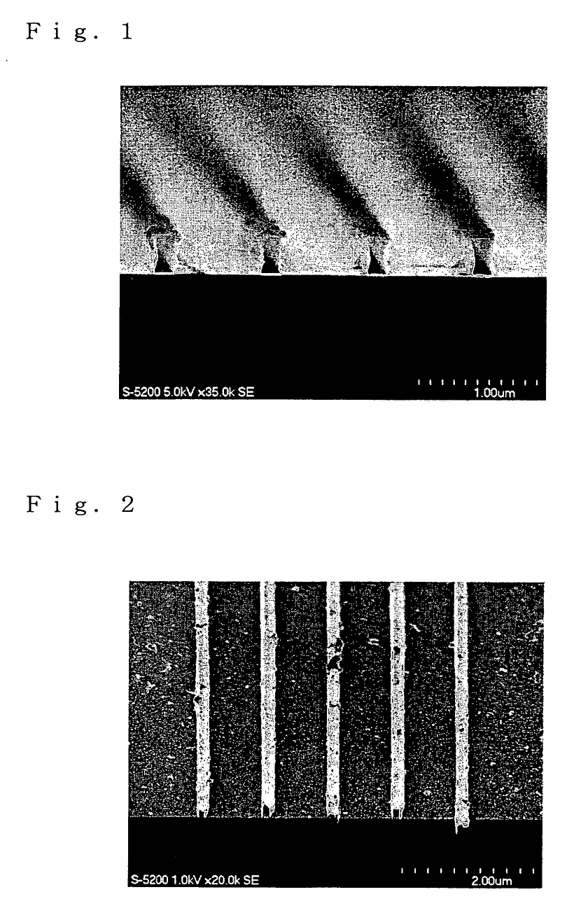

A silicon wafer substrate having an organic resist formed with a rectangular line structure of 350 nm to 1 μm width, 5 mm depth and 400 nm height by a lithographic method (PDUR-P015PM manufactured by Tokyo Ohka Kogyo Ltd.) was previously applied with an oxygen plasma treatment in order to activate the surface of the organic resist (10 W, 23.9 Pa (180 mtorr), 10 min). Then, the substrate was dipped in 10 ml of a titanium normal butoxide (Ti(O-nBu)₄) solution (heptane 100 mM) for 2 min, then dipped in 10 ml heptane for one min and, further, dipped in 5 ml heptane for 1 min and cleaned. Then, the substrate was dipped in 5 ml ion exchanged water for 1 min to hydrolyze titanium normal butoxide present on the surface, and then dried with a nitrogen gas. The adsorption operation of titanium normal butoxide, cleaning operation with heptane, hydrolyzing operation with ion exchanged water, and drying operation by the nitrogen gas (a series of operations are hereinafter referred to as “titania film lamination operation”) were repeated for 20 times. Then, the substrate was applied with an oxygen plasma treatment (30 W, 23.9 Pa (180 mtorr), 2 hours), to remove the organic resist portion used as a mold. FIG. 1 shows scanning type electron microscopic images for a portion of the obtained nanostructural body. As shown in FIG. 1, while the obtained nanostructural body shrunk somewhat, it can be seen that this is a titania nanotube structural body maintaining the same rectangular structure as that of the mold at a thickness of several tens nm. Further, since the resist material is not observed inside the titania nanotube structural body, it can be seen that the organic resist material was completely removed by the oxygen plasma treatment.

### EXAMPLE 2

A titania nanotube structural body was manufactured by the same method as in Example 1 except for changing the number of titania film laminating operation in Example 1 from 20 times to 10 times. FIG. 2 shows scanning type electron microscopic images for a portion of the obtained nanostructural body. As shown in FIG. 2, it can be seen that a titania nanotube structural body maintaining the same rectangular structure as the mold can be obtained also in a case where the number of titania film laminating operation is 10 times in the same manner as in the case of 20 times.

### EXAMPLE 3

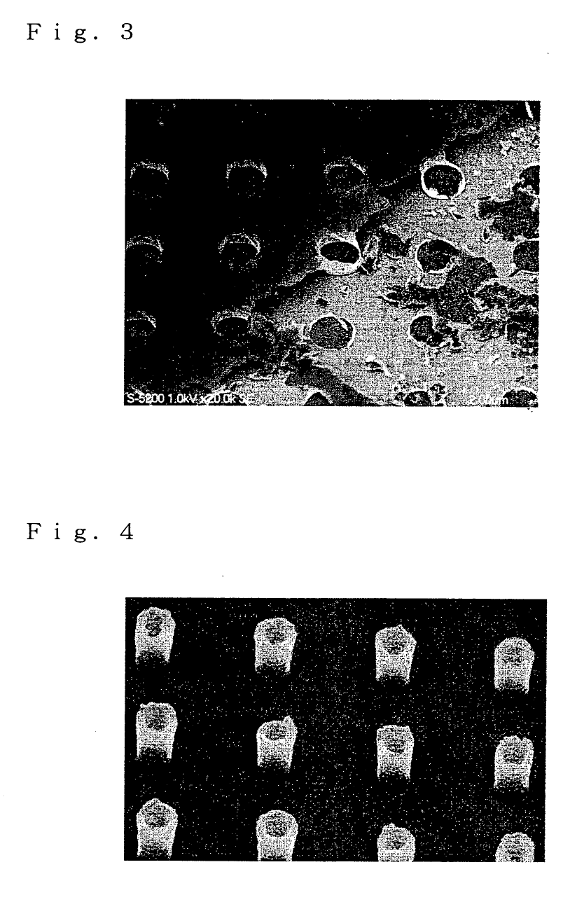

A titania nanostructural body was manufactured by the same method as in Example 1 by using a mold of a structure having a plurality of cylindrical pores each of 300 nm diameter and 400 nm height instead of the mold of the rectangular line structure of Example 1. FIG. 3 and FIG. 4 show scanning type electron microscopic images of the obtained nanostructural body. As shown in FIG. 3, a roof type structural body in which cylindrical nanotube structural bodies each of 300 nm diameter are connected with each other by a thin film of about 10 nm thickness was formed (in FIG. 3, a portion is fractured for easy understanding of the cross sectional state). Thus, it can be seen that a nanostructural body accurately reproducing the shape of the mold can be obtained by the production method of the invention. Further, FIG. 4 shows a structure for a portion of the structure in which a roof portion in the obtained titania nanostructural body is removed. As can be seen from FIG. 4, it can be seen that also the shape for the pore portion of the mold is reproduced accurately.

### EXAMPLE 4

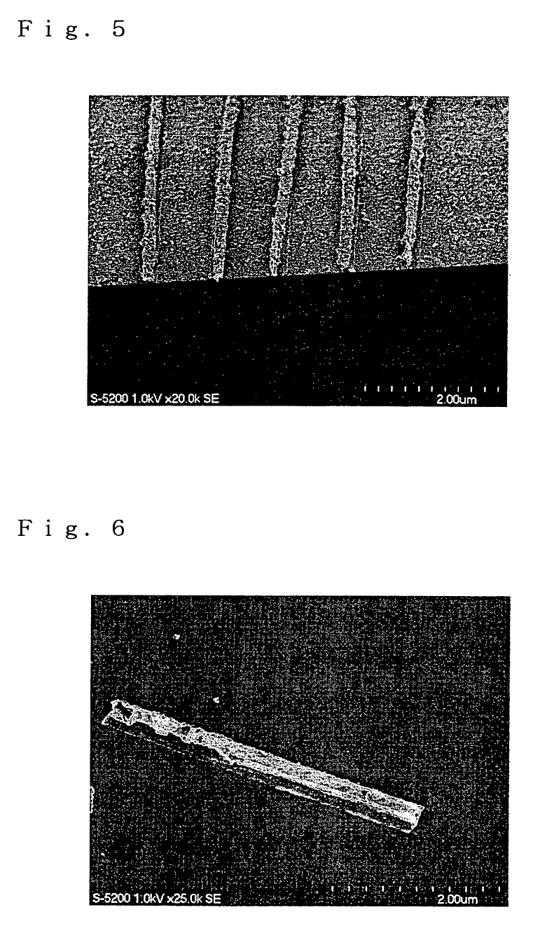

A silicon wafer substrate having an organic resist forming a rectangular line structure of 350 nm to 1 μm width, 5 mm depth and 400 nm height by a lithographic method (PDUR-P015PM manufactured by Tokyo Ohka Kogyo Ltd.) was previously applied with an oxygen plasma treatment in order to activate the surface of the organic resist (10 W, 23.9 Pa (180 mtorr), 10 min). Then, the substrate was dipped in 10 ml of a titanium normal butoxide (Ti(O-nBu)₄) solution (heptane 100 mM) for 2 min, then dipped in 10 ml heptane for one min and, further, dipped in 5 ml heptane for 1 min and cleaned. Then, the substrate was dipped in 5 ml ion exchanged water for 1 min to hydrolyze titanium normal butoxide present on the surface, and then dried with a nitrogen gas. The titania film laminating operation was repeated for 20 times. Then, the substrate was heated from a room temperature to 400° C. for 150 min, kept at 400° C. for 4 hours, and then spontaneously cooled to the room temperature. FIG. 5 shows scanning type electron microscopic images for the surface of the substrate after baking treatment. As shown in FIG. 5, it can be seen that also by the removing method of the mold by baking, the formed titania nanostructural body has a shape reproducing the structure of the mold accurately in the same manner as in the removing method by the oxygen plasma treatment.

### EXAMPLE 5

The titania nanotube structural body obtained in Example 1 was dipped in 0.5 ml ethanol which was applied with a supersonic treatment by a bath type sonicator for 10 sec. Then, the ethanol solution was fractioned by 0.1 ml, dropped on a silicon substrate heated to 100° C. and ethanol was evaporated. The surface of the silicon substrate was observed by a scanning type electron microscope. FIG. 6 shows scanning type electron microscopic images. As shown in FIG. 6, it can be seen that a rectangular nanostructural body of about 300 nm width and about 2 μm length was observed. Since the line width was substantially the same width as that for the organic resist material, it can be seen that a nanostructural body formed by separating a silicon wafer from the titania nanotube structural body manufactured in Example 1 was obtained by the supersonic treatment.

### EXAMPLE 6

A silicon wafer substrate having an organic resist forming a rectangular line structure of 150 nm to 1 μm width, 5 mm depth and 400 nm height by a lithographic method (PDUR-P015PM manufactured by Tokyo Ohka Kogyo Ltd.) was previously applied with an oxygen plasma treatment in order to activate the surface of the organic resist (10 W, 23.9 Pa (180 mtorr), 10 min).

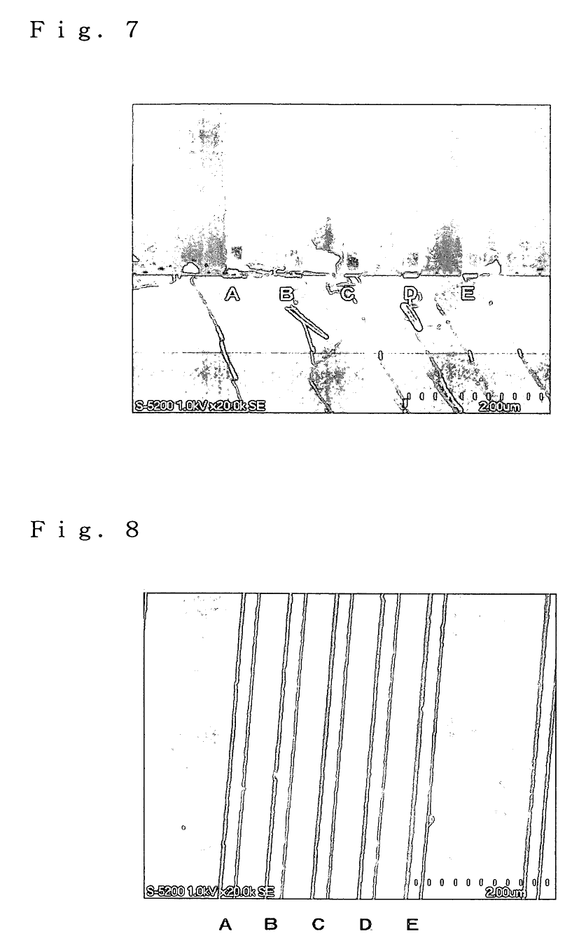

Then, after dipping the substrate in a 10 ml silicon tetraisocyanate (Si(NCO)₄) solution (heptane 100 mM) for 2 min, it was dipped in 10 ml hexane for one min, further dipped in 10 ml deionized water for 1 min and, finally, dried with a nitrogen gas stream. The operation was repeated for 15 times. Then, the substrate was applied with an oxygen plasma treatment again (irradiated at 30 W for 5 hours and then irradiated at 50 W for 4 hours). Then, the substrate was heated from a room temperature to 400° C. for 150 min and, after keeping at 450° C. for 5 hours, it was spontaneously cooled to the room temperature. FIG. 7 shows scanning type electron microscopic images for the surface of the substrate after the baking treatment. FIG. 7 shows a cross sectional view for the substrate after the oxygen plasma treatment for a portion where the organic resist having the rectangular line structure of 340 nm width was formed and FIG. 8 shows an upper plane view thereof.

As shown in FIG. 7, it can be seen that a silica nanotube having a rectangular structure of about 250 nm with, 5 mm depth, and bout 380 nm height is formed by the baking treatment (refer to A to E in FIG. 7). Further, since the inside of the silica nanotube is completely made hollow, it can been seen that the organic resist material formed inside the silica nanotube is completely removed. Further, as apparent from the upper plane view of FIG. 8 (refer to A to E in FIG. 8), the rectangular surface of the silica nanotube is extremely smooth.

It can be seen from FIG. 7 and FIG. 8 that the rectangular line structure of the mold is accurately reproduced in the silica layer, and the structural body of the nanometer size is a structural body having the self-sustainability formed from the silica thin film.

### INDUSTRIAL APPLICABILITY

Since the nanomaterial according to the present invention can provide a material having the three-dimensional nanostructural body having a shape of transcribing or replicating the mold, it is applicable to various fields such as super-thin sheets, micro fine metal fibers, etc. which have been considered difficult to manufactured so far. Further, in a case where the nanomaterial of the invention is a composite material, extended application use can be expected as functional biobody materials and medical materials incorporated with proteins such as enzymes.

Further, since the nanomaterial of the invention can be obtained as a self-sustainable material by laminating the organic/metal oxide composite thin film having various forms at a nanometer accuracy, the material per se can be designed for new electric and electronic characteristics, magnetic characteristics and optical functional characteristics. Specifically, it can be used for the manufacture of semiconductor super lattice materials, and design for highly efficient photochemical reaction or electrochemical reaction. Further, since the production cost of the nanomaterial of the invention is remarkably lower compared with other methods, it can be a practical basic technology for light energy conversion systems in solar cells and the like.

Further, the nanomaterial according to the invention enables manufacture of various gradient functional materials by changing the lamination ratio stepwise for two or more kinds of metal compounds. Further, designs for various types of organic and ion organic composite super thin films are possible by combination with many sequential adsorption methods of organic compounds proposed so far and super-thin films having novel optical, electronic and chemical functions can be manufactured.

Further, the nanomaterial containing the amorphous organic/metal oxide composite thin film has a density lower than the existent nanomaterials containing usual metal oxides, and it can be expected for utilization as thin film materials of super low dielectric constant and application for the manufacture of various kinds of sensors and, particularly, it is prospective as insulative materials for circuits patterned at 10 to 20 nm size or electronic circuits with evenness, or as masking or coating films upon applying super-micro fabrication on the surface of solids.

Further, since the amorphous organic/metal oxide composite thin film has a great number of pores of the molecular size, it can be utilized also for catalyst support or the synthesis of novel substances by utilizing incorporation of ions. Further, different chemical, dynamical and optical characteristics can be provided to the material surface when utilizing it as coating films for various kinds of materials, and application use as photocatalysts or super hydrophilic surfaces can also be expected.

1. A method of producing a nanomaterial comprising forming a mold by a lithographic method on a solid substrate, forming a metal oxide thin film or an organic/metal oxide composite thin film on the formed mold, and removing the formed mold to form a metal oxide nanostructural body or an organic/metal oxide composite nanostructural body.

2. A method of producing a nanomaterial comprising forming a mold on a solid substrate by a lithographic method, forming a polymeric thin film on the formed mold, forming a metal oxide thin film or an organic/metal oxide composite thin film on the formed polymeric thin film, and removing the formed polymeric thin film or the mold and the polymeric thin film thereby forming a metal oxide nanostructural body or an organic/metal oxide composite nanostructural body.

3. The production method according to claim 1 comprising removing a portion corresponding to an organic compound contained in the organic/metal oxide composite thin film.

4. The production method according to claim 1 comprising separating the solid substrate or the solid substrate and the mold, and the metal oxide nanostructural body or the organic/metal oxide composite nanostructural body.

5. The production method according to claim 3, comprising separating the solid substrate or the solid substrate and the mold, and a structural body removed with a portion corresponding to the organic compound contained in the organic/metal oxide composite thin film.

6. The production method according to claim 1, comprising covering at least a portion of the metal oxide nanostructural body, the organic/metal oxide composite nanostructural body, or the structural body removed with a portion corresponding to the organic compound contained in the organic/metal oxide composite thin film.

7. The production method according to claim 1, wherein the following processes are conducted at least once during the formation of the metal oxide thin film or the organic/metal oxide composite thin film:
(a) bringing a metal compound or a combination of an organic compound and a metal compound into contact with the forming surface, the metal compound and the combination of an organic compound and a metal compound having groups capable of conducting condensing reaction with hydroxyl groups or carboxyl groups which are present at or introduced in the forming surface and forming hydroxyl groups by hydrolysis, and
(b) hydrolyzing the metal compound present at the forming surface to obtain a metal oxide.

8. The method according to claim 1, wherein a mold comprising an organic compound is used as the mold.

9. The method according to claim 1, wherein removal of the mold, the polymeric thin film and/or the organic compound contained in the organic/metal oxide composite thin film is conducted by at least one of treating methods selected from plasma, ozone oxidation, leaching and baking.

10. A nanomaterial having a structure removed with a portion corresponding to a mold from a structural body in which a mold, a metal oxide thin film, or an organic/metal oxide composite thin film are formed in this order on a solid substrate.

11. A nanomaterial having a structure in which a portion corresponding to a polymeric thin film or a mold and the polymeric thin film is removed from a structural body in which the mold, the polymeric thin film, and a metal oxide thin film or an organic/metal oxide composite thin film are formed in this order on a solid substrate.

12. The nanomaterial according to claim 10, having a structure removed with a portion corresponding to an organic compound contained in the organic/metal oxide composite thin film.

13. The nanomaterial according to claim 10, having a structure in which the solid substrate is separated.

14. The nanomaterial according to claim 11 having a structure in which the solid substrate and the mold are separated.

15. The nanomaterial according to claim 13 having a structure in which at least a portion of the metal oxide nanostructural body, the organic/metal oxide composite nanostructural body, or a structural body removed with a portion corresponding to an organic compound contained in the organic/metal oxide composite thin film is removed is covered with an organic compound layer.

16. The nanomaterial according to claim 10, wherein removal of mold, the polymeric thin film and/or the portion corresponding to the organic compound contained in the organic/metal oxide composite thin film is conducted by at least one of treatments selected from the group consisting of plasma, ozone oxidation, leaching and baking.

17. A nanomaterial obtained by the method according to claim 1.

18. A self-sustainable nanomaterial consisting of the nanomaterial according to claim 10.
